(19) United States
(12) Patent Application Publication
(10) Pub. No.: US 2024/0413336 A1
(43) Pub. Date: Dec. 12, 2024

(54) CONDUCTIVE BINDER MATERIALS

(71) Applicant: Mylar Specialty Films U.S. Limited Partnership, Chester, VA (US)

(72) Inventors: Stephen SANKEY, Wilton (GB); Stephen JONES, Wilton (GB); Megan Alicia MEABURN, Wilton (GB); Lucien SCHOSSELER, Luxembourg (LU); David TURNER, Wilton (GB)

(21) Appl. No.: 18/706,555

(22) PCT Filed: Nov. 3, 2022
(86) PCT No.: PCT/GB2022/052766

§ 371 Date: May 1, 2024

(30) Foreign Application Priority Data
Nov. 3, 2021 (GB) 2115767.2

(51) Int. Cl. H01M 4/62; H01M 4/02; H01M 4/04; H01M 4/505; H01M 4/525; H01M 4/58; H01M 4/583; H01M 4/66; H01M 10/0525; H01M 50/414

(52) U.S. Cl. CPC H01M 4/622; H01M 4/0404; H01M 4/505; H01M 4/525; H01M 4/5825; H01M 4/583; H01M 4/624; H01M 4/667; H01M 4/668; H01M 10/0525; H01M 50/414; H01M 2004/027; H01M 2004/028

(57) ABSTRACT

An electrode constituted by an active material and a binder material, wherein the binder material comprises a copolyester which comprises repeating units derived from a diol, a dicarboxylic acid and a poly(alkylene oxide). The binder material may further comprise a first metal ion-containing component selected from conductive ceramic particulate materials, and/or may further comprise additional metal ions from one or more sources other than said conductive ceramic particulate materials.

This invention relates to binder materials, to electrodes made therefrom, and methods for their manufacture. In particular, the present invention is concerned with binder materials and electrodes which exhibit the properties required for use as electrodes in metal-ion batteries, particularly lithium-ion batteries.

Lithium-ion batteries are widely used in the field of rechargeable batteries which is set to continually grow over the foreseeable future due, in part, to the increasing demand for consumer electronics and storage of renewable energy. During battery operation (i.e. during charging and discharging), lithium ions are transferred between the electrodes (i.e. between the anode and cathode). Typically, the electrodes are each independently made up of multiple components, including an electrochemically active material, an optional electrically conductive additive (such as carbon) and a binder material. The binder material must enable migration of the lithium ions through the electrode. Furthermore, the binder material plays an important role in the mechanical stability of the electrode. The binder material is typically a fluoride resin, particularly polyvinylidene fluoride (PVDF), in view of its favourable rheological properties and electrochemical stability. Typically, a composition or slurry of these multiple components is coated or otherwise deposited as a thin film onto a current collector and forms a solid electrode upon drying. Thus, the solid anode is in contact with the anode current collector and the solid cathode is in contact with the cathode current collector.

A problem with known electrodes is that they are not readily recyclable. At high temperatures used during metal extraction, toxic gases can form from the decomposition of the PVDF binder. However, it is challenging to separate and recover the PVDF binder, not least because there are few solvents which are able to dissolve PVDF such that it can be recovered from spent electrodes in an environmentally friendly manner. Typical solvents which are able to dissolve PVDF themselves have environmental concerns. It would therefore be desirable to provide binder materials and electrodes which are more readily recyclable than known electrodes comprising PVDF binders, for example by providing binder materials and electrodes which can be recycled whilst avoiding the solvents typically used to dissolve PVDF.

Commercially available lithium-ion batteries are usually provided as wet-cell batteries which contain a microporous separator and a liquid or gel electrolyte. The microporous separator is placed between and in contact with the two solid electrodes. Generally, microporous separators for lithium-ion batteries have a thickness of about 20 μm to about 25 μm and are based on drawn polyolefin films (particularly polyethylene and polypropylene). The separator enables the movement of the liquid or gel electrolyte through its pores, thereby enabling movement of the lithium ions, but prevents direct electric contact between the anode and cathode in the battery. However, there remain concerns about the safety of wet-cell lithium-ion batteries, which have been known to catch fire or even explode. The porous network can lead to growth of lithium dendrites between the anode and cathode, which can result in short-circuiting of the battery, thermal run-away and flammability.

Dry-cell batteries have been developed which reduce some of the above safety concerns. These dry-cell batteries instead contain a solid separator between the two solid electrodes, which prevents contact between the electrodes and provides a physical barrier to the growth of dendrites. In dry-cell batteries, the potentially flammable liquid or gel electrolyte is eliminated. Thus, the separator must effectively function as both separator and electrolyte, and so, for lithium-ion batteries, the separator must enable migration of the lithium ions within its structure.

In particular, migration of the lithium ions must be enabled across the separator-electrode interfaces. High interfacial compatibility between each the solid electrodes and the separator is therefore desired in order to facilitate lithium ion migration. However, it is challenging to achieve interfacial compatibility between solid electrodes and a solid separator in a dry-cell battery which is comparable to that achieved in a wet-cell battery where wetting enables the liquid electrolyte to fully infiltrate into the electrodes. It would therefore be desirable to improve the interfacial compatibility between the solid electrodes and the solid separator in a dry-cell battery.

Furthermore, during battery operation, the volume of the anodes and cathodes change. Additionally, the battery may be exposed to conditions of elevated temperature for extended times. Thus, the separator needs to accommodate these variations in volume during battery cycling, whilst maintaining contact between the separator and the electrodes. It would therefore be desirable to improve the retention of interfacial contact between the solid electrodes and the solid separator in a dry-cell battery during use of the battery, and hence improve the cycling ability and lifetime of the battery.

It is an object of the invention to address one or more of the aforementioned problems. In particular, it is an object of the present invention to provide improved binder materials for use in an electrode of a metal-ion battery, preferably for use in a lithium-ion battery. It is a particular object of the invention to provide binder materials and electrodes which are more readily recyclable. It is also a particular object of the invention to provide electrodes which exhibit improved interfacial compatibility with separators during manufacture of a metal-ion battery, preferably a lithium-ion battery. It is also a particular object of the invention to provide electrodes which exhibit improved interfacial compatibility with separators, and which are able to advantageously retain the interfacial contact during end-use of the battery, and hence improve the cycling ability and lifetime of the battery. It is a further object to provide an electrode with increased electronic conductivity.

The present invention is particularly directed to lithium-ion batteries. Thus, the terms “metal ion”, “metal” and “metal-ion battery” as used in the preceding paragraph and in the corresponding context hereinbelow preferably refer to “lithium ion”, “lithium” and “lithium-ion battery”, respectively. However, the present invention is also applicable to other rechargeable metal-ion batteries, including sodium, potassium, calcium, magnesium and aluminium, particularly sodium, magnesium and aluminium, and particularly sodium.

In a first aspect, the invention provides an electrode constituted by an active material and a binder material, wherein the binder material comprises a copolyester which comprises repeating units derived from a diol, a dicarboxylic acid and a poly(alkylene oxide), and wherein the binder material may further comprise a first metal ion-containing component selected from conductive ceramic particulate materials, and/or may further comprise additional metal ions from one or more sources other than said conductive ceramic particulate materials.

It will be appreciated that the term “electrode constituted by” as used in the first aspect and in the corresponding context hereinbelow refers to an electrode comprising an active material and a binder material or to an electrode derived from a composition comprising an active material and a binder material.

Thus, in one embodiment, the electrode comprises the active material and the binder material. Optionally, the electrode consists essentially of the active material and the binder material. In other words, the electrode does not include any further components which contribute towards the electrochemical activity of the electrode. Optionally, the electrode consists of the active material and the binder material.

In an alternative embodiment, the electrode is derived from a composition comprising an active material and the binder material. The composition may further comprise a liquid vehicle. Typically, the liquid vehicle is removed from the composition as the electrode is formed.

Preferably, the binder material further comprises said first metal ion-containing component selected from conductive ceramic particulate materials.

It will be appreciated that, for utility in a metal-ion battery, the metal of said first metal ion-containing component of said film is preferably the same as the metal of said additional metal ions (which is also referred to hereinbelow as the second metal ion-containing component).

Preferably, said first metal ion-containing component is a first lithium ion-containing component, and in that instance said additional metal ions are preferably additional lithium ions. Alternatively, said first metal ion-containing component is a first sodium ion-containing component, and in that instance said additional metal ions are preferably additional sodium ions.

Thus, in a preferred embodiment, the first aspect of the present invention provides an electrode constituted by an active material and a binder material, wherein the binder material comprises said copolyester and a first metal ion-containing component selected from conductive ceramic particulate materials.

Preferably, the binder material comprises said additional metal ions. Where present, said additional metal ions are preferably present in the form of a second metal ion-containing component, preferably selected from metal salts, preferably selected from lithium or sodium salts, preferably selected from lithium salts.

Thus, in a preferred embodiment, the first aspect of the present invention provides an electrode constituted by an active material and a binder material, wherein the binder material comprises said copolyester and a metal-ion containing component selected from metal salts.

In a particularly preferred embodiment, the first aspect of the present invention provides an electrode constituted by an active material and a binder material, wherein the binder material comprises said copolyester, a first metal ion-containing component selected from conductive ceramic particulate materials, and a second metal ion-containing component selected from metal salts. It will be appreciated that said first and second metal ion-containing components are different from each other.

In a particularly preferred embodiment, the first aspect of the present invention provides an electrode constituted by an active material and a binder material, wherein the binder material comprises said copolyester, a first lithium ion-containing component selected from conductive ceramic particulate materials, and a second lithium ion-containing component selected from lithium salts. It will be appreciated that said first and second lithium ion-containing components are different from each other.

In an alternative embodiment, the first aspect of the present invention provides an electrode constituted by an active material and a binder material, wherein the binder material comprises said copolyester, a first sodium ion-containing component selected from conductive ceramic particulate materials, and a second sodium ion-containing component selected from sodium salts. It will be appreciated that said first and second sodium ion-containing components are different from each other.

The electrode of the invention may be a cathode or an anode. The electrodes of the invention are more readily recyclable than known electrodes comprising PVDF binders. The inventors have surprisingly found that electrodes of the invention exhibit good interfacial compatibility with subsequently disposed separators, particularly solid separators in dry-cell batteries. The inventors have surprisingly found that electrodes of the invention also retain good interfacial contact during end-use of the battery.

The binder material comprises a copolyester which comprises repeating units derived from a diol, a dicarboxylic acid and a poly(alkylene oxide), and which may further comprise a first metal ion-containing component selected from conductive ceramic particulate materials, and/or which may further comprise additional metal ions from one or more sources other than said conductive ceramic particulate materials.

As used herein, the term “copolyester” refers to a polymer which comprises ester linkages and which is derived from three or more types of comonomers. The copolyesters described herein are thermoplastic.

Suitable dicarboxylic acids for the copolyester include aromatic dicarboxylic acids such as terephthalic acid, isophthalic acid, phthalic acid and naphthalene dicarboxylic acid (such as 2,5-, 2,6- or 2,7-naphthalene dicarboxylic acid), as well as aliphatic dicarboxylic acids such as succinic acid, sebacic acid, adipic acid and azelaic acid. Cycloaliphatic dicarboxylic acids may also be used. Other suitable dicarboxylic acids include 4,4′-diphenyldicarboxylic acid and hexahydro-terephthalic acid. Preferably, the dicarboxylic acid used in the present invention is an aromatic dicarboxylic acid, preferably terephthalic acid or isophthalic acid, preferably terephthalic acid.

The copolyester preferably comprises at least one aromatic dicarboxylic acid, preferably terephthalic, isophthalic, or naphthalene dicarboxylic acids, and preferably terephthalic acid or isophthalic acid, and preferably terephthalic acid. In a first and most preferred embodiment, the dicarboxylic acid component comprises only one aromatic dicarboxylic acid. In a second embodiment, the dicarboxylic acid component comprises a first aromatic dicarboxylic acid (preferably terephthalic acid or isophthalic acid, preferably terephthalic acid) and a second dicarboxylic acid. The second dicarboxylic acid may be selected from aliphatic dicarboxylic acids such as succinic acid, sebacic acid, adipic acid or azelaic acid, and in one embodiment the second dicarboxylic acid is azelaic acid.

Suitable diols for the copolyester include acyclic, alicyclic and aromatic dihydroxy compounds. Preferred diols have 2-15 carbon atoms, and include ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, and 1,5-dihydroxynaphthalene, etc. An aliphatic diol is preferred, especially acyclic aliphatic diols containing 2-8 carbon atoms, especially aliphatic diols containing 2-4 carbon atoms. An unbranched aliphatic diol is preferred. Preferably the diol is selected from ethylene glycol, 1,3-propanediol and 1,4-butanediol, more preferably from ethylene glycol and 1,4-butanediol, and most preferably ethylene glycol. Cycloaliphatic (alicylic) glycols such as 1,4-cyclohexanedimethanol (CHDM) can also be used. Equivalent ester-forming derivatives of diols may be used in place of said diol. Preferably, the copolyester comprises only one type of diol residue. In one embodiment, at least 90 mol %, preferably at least 95 mol %, preferably at least 98 mol %, and preferably at least 99 mol % of said diol fraction is made up of one type of diol.

Suitable poly(alkylene oxide)s for the copolyester are preferably selected from C₂ to C₁₅, preferably C₂ to C₁₀, preferably C₂ to C₆ alkylene chains. The poly(alkylene oxide) may be selected from polyethylene glycol (PEG), polypropylene glycol (PPG) and poly(tetramethylene oxide) glycol (PTMO), preferably polyethylene glycol. Ethylene oxide-terminated poly(propylene oxide) segments may also be used. In one embodiment, the copolyester comprises only one type of poly(alkylene oxide) residue. In an alternative embodiment, the copolyester comprises two or more types of poly(alkylene oxide) residues, such as mixture of polyethylene glycol (PEG) and polypropylene glycol (PPG).

The number average molecular weight (M_{N}) of the poly(alkylene oxide) glycol is preferably from about 200 g/mol to about 20000 g/mol, preferably from about 200 g/mol to about 6000 g/mol, preferably from about 200 g/mol to about 5000 g/mol, preferably no more than about 5000 g/mol, preferably no more than about 4000 g/mol, preferably from about 400 g/mol to about 3900 g/mol, preferably at least about 500 g/mol, preferably from about 500 g/mol to about 3800 g/mol, most preferably from about 500 g/mol to about 3700 g/mol, preferably from about 800 g/mol to about 3600 g/mol, preferably from about 1000 g/mol to about 3600 g/mol, preferably from about 2000 g/mol to about 3500 g/mol, and preferably from about 3350 to about 3450 g/mol, and preferably about 3350 g/mol or about 3450 g/mol. The number average molecular weight (M_{N}) of the poly(alkylene oxide) is preferably at least about 200 g/mol, preferably at least about 400 g/mol, preferably at least about 500 g/mol, and preferably at least about 800 g/mol, for example at least about 1000 g/mol. The number average molecular weight (M_{N}) of the poly(alkylene oxide) is preferably no more than about 20000 g/mol, preferably no more than about 5000 g/mol, preferably no more than about 4000 g/mol, and preferably no more than about 3800 g/mol, for example no more than about 3700 g/mol.

It has been found that if the molecular weight of the poly(alkylene oxide) is too high, it becomes harder to co-polymerise with the dicarboxylic acid and diol to form a copolyester with a sufficiently high melt viscosity for reliable film formation. In addition, it has been found that if the molecular weight of the poly(alkylene oxide) is too high, the conductivity may decrease.

Unless the context indicates otherwise the term molecular weight as used herein refers to number average molecular weight (M_{N}) which is measured by the method as described herein.

The polydispersity index, PDI, (or dispersity, D) is defined as M_{W}/M_{N}, where M_{W} is the weight average molecular weight. The polydispersity index is a measure of the uniformity (or heterogeneity) of the size of the different macromolecules that comprise a polymer (which is a mixture of macromolecules of different sizes). Compositions with a polydispersity index of 1 (i.e. which are monodisperse) consist of macromolecules each of which has the same size (such as dendrimers). Monodisperse compositions of macromolecules are typically made by non-polymerisation processes and are typically not referred to as polymers.

The poly(alkylene oxide) of the copolyester preferably has a polydispersity index of above 1, preferably at least about 1.01, preferably at least about 1.1, preferably at least about 1.2, and preferably no more than about 2.0, preferably no more than about 1.8, preferably no more than about 1.6, and preferably from about 1.01 to about 2.0, preferably about 1.1 to about 1.8, and preferably about 1.2 to about 1.6.

The copolyesters may be block (segmented) copolymers comprising alternating random-length sequences joined by ester linkages. Such copolyesters exhibit semi-crystalline (or hard) segments derived from an dicarboxylic acid and an diol, and amorphous (or soft) segments derived from poly(alkylene oxide). For example, hard segments are made up of repeating units of [R₁—O—C(═O)-A-C(═O)—O] wherein R₁ is derived from the aliphatic diol and A is the aromatic ring (preferably phenyl or naphthyl) derived from the aromatic dicarboxylic acid defined hereinabove. Soft segments are made up of repeating units of [R—O] where R is the alkylene chain from the poly(alkylene oxide). The soft segments may be end-capped with said dicarboxylic acid via an ester linkage.

In a further embodiment, the copolyesters are random copolymers, in which the dicarboxylic acid, diol and poly(alkylene oxide) units are arranged in a random sequence in the copolyester backbone.

Between these two extremes of random and block copolymers lie copolyesters which are referred to herein as “block-like” copolymers. In the block-like copolymers, the poly(alkylene oxide) units are interspersed between the dicarboxylic acid units to a greater degree than in the block copolymers, such that the crystalline (or hard) segments noted above are, on average, significantly shorter than in the block copolymers. The sequence of the comonomer units in the copolymer chain, i.e. the degree of randomness of the copolyester, may be determined using conventional techniques known in the art, and preferably by ¹³C NMR spectroscopy as described herein. The copolyester can be characterised as a block, block-like or random copolyester by quantifying the degree of randomness, B, with a value of 0 representing a pure block copolymer and a value of 1 representing a statistically random copolymer as defined by a Bernoulli model.

Preferably, B is in the range of from about 0.1 to 1.0, preferably from about 0.2 to about 0.95, preferably from about 0.3 to about 0.9, preferably from about 0.4 to about 0.8, for example from about 0.5 to about 0.7. The copolyester preferably has a value of B of at least about 0.1, preferably at least about 0.2, preferably at least about 0.3, and preferably at least about 0.4, for example at least about 0.5. The copolyester preferably has a value of B of no more than 1.0, preferably no more than about 0.95, preferably no more than about 0.9, preferably no more than about 0.8, and preferably no more than about 0.7.

Preferably, the copolyesters of the present invention are the “block-like” copolyesters or the random copolyesters.

More preferably, the copolyesters of the present invention are the “block-like” copolyesters, which are obtainable by selecting the molecular weight for the poly(alkylene oxide) as described herein.

It has been found that the molecular weight of the poly(alkylene oxide) has a significant influence on the sequence of the comonomers in the copolyester, and the characterisation of the copolymer as a block, block-like or random copolymer. Thus, lower molecular weight poly(alkylene oxide)s favour the formation of random copolymers, and higher molecular weight poly(alkylene oxide)s favour the formation of block copolymers. Block copolymers typically exhibit a greater tendency to crystallise and a higher melting temperature, relative to the corresponding random copolymers. Higher melting temperatures are preferably avoided in the present invention, since they require higher processing temperatures and there is a greater risk of degradation. In addition, it is preferred in the present invention to avoid the increased tendency of the pure block copolymers to crystallise, since this may hinder the migration of metal ions within the structure of the copolymer and may reduce its conductivity.

The poly(alkylene oxide) preferably constitutes from about 0.1 to about 80 wt %, preferably from about 5 to about 78 wt %, preferably from about 10 to about 75 wt %, preferably from about 12 to about 65 wt %, preferably from about 15 to about 60 wt %, preferably from about 16 to about 55 wt % by total weight of the copolyester.

Preferably, the poly(alkylene oxide) constitutes at least about 0.1 wt %, preferably at least about 5 wt %, preferably at least about 10 wt %, preferably at least about 12 wt %, preferably at least about 15 wt %, preferably at least about 16 wt %, preferably no more than about 80 wt %, preferably no more than about 78 wt %, preferably no more than about 75 wt %, preferably no more than about 65 wt %, preferably no more than about 60 wt %, preferably no more than about 55 wt % by total weight of the copolyester.

Where the copolyester comprises repeating units derived from a diol (preferably ethylene glycol), terephthalic acid and a poly(alkylene oxide), the poly(alkylene oxide) is preferably present in an amount of from about 5 to about 30 wt %, preferably from about 10 to about 25 wt %, preferably from about 15 to about 20 wt % of the total weight of the copolyester.

Where the copolyester comprises repeating units derived from a diol (preferably ethylene glycol), isophthalic acid and a poly(alkylene oxide), the poly(alkylene oxide) is preferably present in an amount of from about 35 to about 65 wt %, preferably from about 40 to about 60 wt %, preferably from about 45 to about 55 wt % of the total weight of the copolyester.

The amount of copolyester present in the binder material is preferably no more than about 99.9 wt % by total weight of the binder material, preferably no more than about 95 wt %, preferably no more than about 92 wt %, preferably no more than about 90 wt %. Preferably, the amount of copolyester present in the binder material is at least about 40% by total weight of the binder material, preferably at least about 50 wt %, preferably at least about 65 wt %, preferably at least about 80 wt %. Thus, the amount of copolyester present is preferably from about 40 wt % to about 99.9 wt %, preferably from about 50 wt % to about 95 wt %, preferably from about 65 wt % to about 92 wt %, preferably from about 80 to about 90 wt % by total weight of the binder material.

Said copolyester is preferably the only polyester present in the binder material.

As described hereinabove, the binder material preferably comprises a first lithium ion-containing component, which is selected from conductive ceramic particulate materials. One or more conductive ceramic particulate materials may be present.

It will be appreciated by those skilled in the art that a ceramic material is an inorganic non-metallic solid comprising both metallic and non-metallic elements which is formed or densified by heating at high temperatures. Ceramic materials are typically hard, brittle and corrosion resistant, with low chemical reactivity and high melting points. The ceramic materials referred to herein may be crystalline or glassy.

The ceramic particulate materials used in the present invention are conductive. The invention is primarily illustrated below in respect of lithium ion-containing conductive ceramic particulate materials, but the technical principles are generally applicable to other metal ion-containing conductive ceramic particulate materials.

Any suitable lithium ion-containing conductive ceramic particulate material may be used, particularly NASICON-type ceramic particulate materials (such as lithium ion-containing conductive glass ceramic particulate materials), LISICON-type ceramic particulate materials, perovskite-type oxide ceramic particulate materials, garnet-type oxide ceramic particulate materials, lithium phosphorus oxynitride (LIPON)-type ceramic particulate materials and lithium aluminium silicate (LAS) ceramic particulate materials.

As is known in the art, NASICON (sodium super ionic conductor) materials refer to a family of solids with the chemical formula Na₁₊ₓZr₂SiₓP₃₋ₓO₁₂ where 0<x<3, as well as analogous compounds where Na, Zr and/or Si are replaced by isovalent elements, and so in the context of the most preferred aspect of the present invention the sodium is replaced with lithium. Particularly suitable lithium-containing NASICON-type ceramic particulate materials may have the general formula LiM_{y}(PO₄)₃, where M denotes a multivalent metal ion. For example, M may be selected from one or more of Al, Si, Ti, Zr, Ge, Sn and Hf. Other suitable lithium-containing NASICON-type ceramic particulate materials may have the general formula Li₁₊ₓMₓTi₂₋ₓ(PO₄)₃ (LATP), where M denotes a trivalent cation selected from one or more of Al, Sc, Y and La. Other suitable lithium-containing NASICON-type ceramic particulate materials may have the general formula Li₁₊ₓAlₓGe₂₋ₓ(PO₄)₃ (LAGP), for example wherein x is 0.5.

Particularly suitable are lithium ion-containing conducting glass ceramic particulate materials which have a NASICON-structure. Preferred particulate materials are those commercially available under the tradename “LICGC” from Ohara Inc. A preferred particulate material is commercially available as LICGC™ PW-01 powder from Ohara Inc., which is understood as having a main crystalline phase of Li_{1+x+y}AlₓTi₂₋ₓSi_{y}P_{3-y}O₁₂ and a composition of Li₂O—Al₂O₃—SiO₂—P₂O₅—TiO₂. A further preferred particulate material is commercially available as LICGC™ AG-01 from Ohara Inc., which is understood as having a main crystalline phase of Li_{1+x+y}Alₓ(Ti,Ge)₂₋ₓSi_{y}P_{3-y}O₁₂ and a composition of Li₂O—Al₂O₃—SiO₂—P₂O₅—TiO₂—GeO₂.

As is known in the art, LISICON (lithium super ionic conductor) materials refer to a family of solids with the chemical formula Li₂₊₂ₓZn₁₋ₓGeO₄. As with NASICON-type materials, other elements (typically isovalent elements) may replace the Li, Zn and/or Ge. Suitable LISICON-type particulate materials may be selected from Li₂₊₂ₓZn₁₋ₓGe₄O₁₆, Li₁₄ZnGe₄O₁₆, Li₍₃₊ₓ₎GeₓV₍₁₋ₓ₎O₄, Li₍₄₋ₓ₎Si₍₁₋ₓ₎PₓO₄, and thio-LISICONs such as those having the formula Li₍₄₋ₓ₎Ge₍₁₋ₓ₎PₓS₄Li₁₀GeP₂S₁₂, where x is between 0 and 1.

Suitable perovskite-type oxide particulate materials may be selected from Li₃ₓLa_{(2/3)-x}TiO₃ (LLTO) and Li₃ₓLa_{1/3-x}TaO₃.

Suitable garnet-type oxide particulate materials may have the general formula Li_{7-3y-x}La₃Zr₂₋ₓM1_{y}M2ₓO₁₂ (where M1 denotes a trivalent cation such as Al and Ga, M2 denotes a pentavalent cation such as Nb and Ta, x≥0 and y≤2); Li₅La₃M₂O₁₂ (where M denotes Nb and/or Ta); Li₆ALa₂M₂O₁₂ (where A denotes Ca, Sr and/or Ba, and M denotes Nb or Ta); or Li_{6.5}La_{2.5}Ba_{0.5}ZrTaO₁₂.

Suitable LIPON-type ceramic particulate materials may have the general formula LiₓPO_{y}N_{z}, such as Li₂PO₂N.

Suitable LAS ceramic particulate materials may be selected from AlLiO₆Si₂.

With regard to sodium ion-containing ceramic particulate materials, particularly suitable are NASICON-type ceramic particulate materials (such as sodium ion-containing conductive glass ceramic particulate materials), beta-alumina and beta”-alumina phases Na₂O·nAl₂O₃ where 5≤n≤11, sodium rare earth silicates, and Na-ion conducting oxyhalide glasses. Suitable NASICON-type ceramic particulate materials are NASICON-structured oxides, which may have the general formula Na₃Zr₂Si₂PO₁₂, NaTi₂(PO₄)₃, NaGe₂(PO₄)₃ or Na₁₊ₓ[SnₓGe₂₋ₓ(PO₄)₃]. Suitable sodium rare earth silicates have the general formula Na₅MSi₄O₁₂, where M is Y, Sc, Lu and/or any trivalent rare earth cation. Suitable Na-ion conducting oxyhalide glass may be NaI—NaCl—Na₂O—B₂O₃.

Preferably, the volume distributed median particle diameter (equivalent spherical diameter corresponding to 50% of the volume of all the particles, read on the cumulative distribution curve relating volume % to the diameter of the particles—often referred to as the “Dv50” or “D50” value) of the conductive ceramic particulate material is in the range from 0.01 to 5 μm, preferably from 0.05 to 3 μm, preferably from 0.1 to 2 μm, preferably from 0.2 to 1.5 μm, preferably from 0.4 to 1.0 μm. The particle size may be measured by laser light diffraction (preferably Fraunhofer diffraction). A particularly preferred method utilises a Mastersizer (e.g. a 3000) available from Malvern. The median particle size may be determined by plotting a cumulative distribution curve representing the percentage of particle volume below chosen particle sizes and measuring the 50th percentile.

Where present, the amount of said metal ion-containing conductive ceramic particulate material in the binder material is preferably no more than about 60 wt % by total weight of the binder material, preferably no more than about 50 wt %, preferably no more than about 35 wt %, preferably no more than about 20 wt %, and preferably at least about 0.1 wt %, preferably at least about 5 wt %, preferably at least about 8 wt %, preferably at least about 10 wt %. Thus, the amount of conductive ceramic particulate material present is preferably from about 0.1 wt % to about 60 wt %, preferably from about 5 wt % to about 50 wt %, preferably from about 8 wt % to about 35 wt %, preferably from about 10 to about 20 wt % by total weight of the binder material.

Said metal ion-containing conductive ceramic particulate material is held within the polymeric matrix of the binder material.

As described hereinabove, the binder material preferably comprises additional metal ions from one or more sources other than said conductive ceramic particulate material. Where the conductive ceramic particulate material is a lithium-ion containing conductive ceramic particulate material, the composition preferably comprises additional lithium ions from one or more sources other than said conductive ceramic particulate material. Where the conductive ceramic particulate material is a sodium-ion containing conductive ceramic particulate material, the composition preferably comprises additional sodium ions from one or more sources other than said conductive ceramic particulate material. These additional metal ions are referred to herein as the second metal ion component, for instance as the second lithium ion component or the second sodium ion component. It will be appreciated that said first metal ion-containing component and said second metal ion component are different from each other. The second metal ion component is preferably a metal ion-containing component selected from metal salts. The invention is primarily illustrated below in respect of lithium salts, but the technical principles are generally applicable to other metal salts materials.

Any suitable lithium salt may be used. One or more different types of lithium salts may be used. Preferably the lithium salts are selected from lithium salts suitable for use in lithium ion batteries, such as lithium bis(trifluoromethanesulfonyl)imide (LiTFSI), lithium hexafluorophosphate (LiPF₆), lithium tetrafluoroborate (LiBF₄), lithium thiocyanate (LiSCN), lithium hexafluoroarsenate (LiAsF₆), lithium trifluoromethanesulfonate (LiCF₃SO₃), lithium bromide (LiBr), lithium iodide (LiI), lithium bis(trifluoromethanesulfonimide) (LiN(CF₃SO₂)₂), lithium tris(trifluoromethylsulfonyl)methide (LiC(CF₃SO₂)₃), lithium orthosilicate, lithium trifluoroacetate (LiCF₃CO₂) and lithium bis(fluorosulfite)amide (LiN(FO₂S)₂).

When the electrode is formed using solvent casting techniques, it is preferred that the metal ion is derived from a metal salt which has high solubility in the solvent used in the solvent re-casting steps. Thus, in the case of lithium ion batteries, a particularly preferred lithium salt is lithium trifluoromethanesulfonate (LiCF₃SO₃).

The metal salts (including the preferred lithium salts) may be selected from:
(i) aromatic carboxylic acids, preferably aromatic dicarboxylic acids, preferably terephthalic acid or isophthalic acid;
(ii) aliphatic carboxylic acids, including aliphatic dicarboxylic acids, preferably acetic acid, glycolic acid or succinic acid;
(iii) carbonic acids;
(iv) phenolic acids, preferably salicylic acid;
(v) mineral acids, such as perchloric acid or phosphoric acid, particularly phosphoric acid; and
(vi) boric acids, preferably bis(oxalate)boric acid.

Optionally, the metal salts are selected from metal salts of (i) to (v) provided above.

Thus, suitable lithium salts include: dilithium terephthalate (DLTA), dilithium isophthalate, lithium glycolate, lithium benzoate, lithium acetate, lithium carbonate, lithium perchlorate, lithium orthosilicate, lithium phosphate, lithium salicylate, lithium succinate and lithium bis(oxalato)borate.

Preferably the metal salt is an organic metal salt.

In a preferred embodiment, the metal salt is the salt of the aromatic dicarboxylic acid from which the copolyester is derived. Thus, in the case of the preferred copolyesters derived from terephthalic acid, the lithium salt is preferably selected from mono- or di-lithium terephthalate, and preferably dilithium terephthalate. The inventors have found that dilithium terephthalate is particularly preferable for thermal stability and cost reasons. In the case of the preferred copolyesters derived from isophthalic acid, the lithium salt is preferably selected from mono- or di-lithium isophthalate, and preferably dilithium isophthalate.

Other preferred metal salts may be selected from the alkoxylate esters of the aforementioned acids, particularly the carboxylic acids, particularly the dicarboxylic acids, particularly the aromatic dicarboxylic acids, particularly terephthalic acid. Such alkoxylate esters are preferably derived from the aliphatic diols, preferably from C₂₋₁₀ aliphatic diols, preferably from C₂₋₆ aliphatic diols, preferably from C₂, C₃ or C₄ aliphatic diols, more preferably from ethylene glycol, 1,3-propanediol and 1,4-butanediol, more preferably from ethylene glycol.

A particularly suitable lithium salt has the formula (I) below, and is referred to herein as dilithium bis hydroxy ethyl terephthalate (DL-BHET):

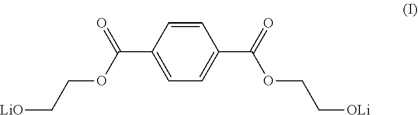

Preferably the lithium salt is selected from lithium trifluoromethanesulfonate (LiCF₃SO₃), dilithium terephthalate or dilithium bis hydroxy ethyl terephthalate. Preferably the lithium salt is selected from dilithium terephthalate.

With regard to the sodium-containing embodiment of the present invention, any suitable sodium salt may be used. One or more different types of sodium salts may be used. It will be appreciated that the preferences and elements described in respect of the lithium salt apply equally to the sodium salt, except that the lithium ions are replaced by sodium ions. Preferably, the sodium salt is selected from sodium nitrate (NaNO₃), sodium perchlorate (NaClO₄), sodium tetrafluoroborate (NaBF₄), sodium hexafluorophosphate (NaPF₆), sodium bis(trifluoromethanesulfonyl)imide (NaTFSI), sodium bis(trifluoromethane)sulfonimide (Na[N(CF₃SO₂)₂]), sodium hexafluoroarsenate(V) (NaAsF₆), sodium bis(oxalatoborate) (“NaBOB”), sodium halides (NaX), where X═Cl, Br or I, sodium thiocyanate (NaSCN), sodium pentacyanopropenide (NaPCPI), sodium tetracyanopirolate (NaTCP) and sodium tricyanoimidazolate (NaTIM).

In one embodiment, the metal ions of said second metal ion component are present in and held within the polymeric matrix of the binder material by virtue of the interaction between the metal cations and the polarisable electronegative oxygen atoms of the copolyester, preferably at least the electronegative oxygen atoms of the polyalkylene oxide units.

In a preferred embodiment, the metal ions of said second metal ion component are held within the polymeric matrix of the binder material by virtue of the interaction between the metal cations and the anion of a metal salt. Thus, in this embodiment, the binder material comprises a metal salt. Preferably at least part, preferably at least 50 wt %, preferably at least 60 wt %, preferably at least 70 wt %, preferably at least 80 wt %, preferably at least 90 wt %, preferably at least 95 wt %, preferably at least 99 wt %, and preferably substantially all of the metal ions of said second metal ion component are in the form of a metal salt. The metal salts are selected from the metal salts described above, and the preferences described above apply here. Thus, in this preferred embodiment, a metal salt is held within the polymeric matrix. In this embodiment, the metal salt is not part of the polymer backbone, i.e. it has not been polymerised into the copolyester. In other words, in this preferred embodiment, the anion of the metal salt is not covalently bound to the copolyester. In the preferred embodiment described above in which the metal salt is the salt of the same aromatic dicarboxylic acid from which the copolyester is derived, the metal-containing copolyester film described herein exhibits excellent thermal stability which is believed to result from the alignment of the morphology of the copolyester with the morphology of the metal salt.

The amount of metal ions of said second metal ion component in the composition is preferably effective to provide a metal:O molar ratio of from about 5:1 to about 1:50, preferably from about 4:1 to about 1:50, preferably from about 3:1 to about 1:50, preferably from about 2:1 to about 1:50, preferably about 1:1 to about 1:40, preferably about 1:2 to about 1:30, preferably about 1:4 to about 1:25, wherein the number of O atoms in this ratio is defined as the number of O atoms in the poly(alkylene oxide) residues, and the number of metal atoms in this ratio is defined as the number of metal atoms provided by said additional metal ions (i.e. said second metal ion component, and excluding said first metal ion-containing component).

Where present, the amount of the second metal ion component (i.e. preferably said metal salts) is preferably no more than about 40 wt %, preferably no more than about 10 wt %, and preferably at least about 0.1%, preferably at least about 1%, and preferably from about 0.1 wt % to about 40 wt %, preferably from about 1 wt % to about 10 wt % by total weight of the binder material.

Where the binder material comprises said first metal-ion containing component and said second metal ion component, the total amount of the first metal ion-containing component and the second metal ion component is preferably no more than about 60 wt % by total weight of the binder material, preferably no more than about 50 wt %, preferably no more than about 35 wt %, preferably no more than about 20 wt %, and preferably at least about 0.1 wt %, preferably at least about 5 wt %, preferably at least about 8 wt %, preferably at least about 10 wt %. Thus, the total amount of the first metal ion-containing component and the second metal ion component present is preferably from about 0.1 wt % to about 60 wt %, preferably from about 5 wt % to about 50 wt %, preferably from about 8 wt % to about 35 wt %, preferably from about 10 to about 20 wt % by total weight of the binder material.

The electrode of the present invention may further comprise any other additive conventionally employed in the manufacture of polyester compositions or polyester films. Thus, agents such as anti-oxidants, thermal stabilisers, and anti-foaming agents may be incorporated as appropriate. Such additives may be introduced into the electrode in a conventional manner. For example, the additive(s) may be introduced by mixing with the monomeric reactants from which the copolyester is derived, or the additive(s) may be mixed with the composition by tumble or dry blending or by compounding in an extruder, followed by cooling and, usually, comminution into granules or chips. Masterbatching technology may also be employed.

In a preferred embodiment, the electrode comprises an anti-oxidant. A range of antioxidants may be used, such as antioxidants which function by trapping radicals or by decomposing peroxide. Suitable radical-trapping antioxidants include hindered phenols, secondary aromatic amines and hindered amines, such as Tinuvin™ 770 (Ciba-Geigy). Suitable peroxide-decomposing antioxidants include trivalent phosphorous compounds, such as phosphonites, phosphites (e.g. triphenyl phosphate and trialkylphosphites) and thiosynergists (e.g. esters of thiodipropionic acid, such as dilauryl thiodipropionate). Hindered phenol antioxidants are preferred. A particularly preferred hindered phenol is tetrakis-(methylene 3-(4′-hydroxy-3′,5′-di-t-butylphenyl propionate) methane, which is commercially available as Irganox™ 1010 (Ciba-Geigy). Other suitable commercially available hindered phenols include Irganox™ 1035, 1076, 1098 and 1330 (Ciba-Geigy), Santanox™ R (Monsanto), Cyanox™ antioxidants (American Cyanamid) and Goodrite™ antioxidants (BF Goodrich). The concentration of antioxidant present in the electrode is preferably in the range from 50 ppm to 5000 ppm, more preferably in the range from 300 ppm to 1500 ppm, particularly in the range from 400 ppm to 1200 ppm, and especially in the range from 450 ppm to 600 ppm based on the weight of the electrode. A mixture of more than one antioxidant may be used, in which case the total concentration thereof is preferably within the aforementioned ranges. The antioxidant may be incorporated into the copolyester and this incorporation may be effected by conventional techniques, and preferably by mixing with the monomeric reactants from which the copolyester is derived, particularly at the end of the direct esterification or ester exchange reaction, prior to polycondensation.

In a further preferred embodiment, the binder material comprises an inorganic particulate filler, preferably selected from metalloid oxides (such as alumina, titania, zirconia, zinc oxide, talc and silica), calcined china clay, alkaline metal salts (such as the carbonates and sulphates of calcium and barium) and non-conductive ceramic particulate materials. The inorganic particulate filler should have a particle size which is smaller than the final electrode thickness, and preferably the particle size is no more than 10 μm, preferably no more than about 5 μm, preferably no more than about 2 μm, preferably in the range of from about 0.5 μm to about 2.0 μm. It will be appreciated that the identity of said inorganic particulate filler (or indeed any other of said conventional additives) is a different entity from the first or second metal ion-containing components described hereinabove. In particular, said inorganic particulate filler (or any other of said conventional additives) does not contain the metal ion of the first or second metal ion-containing components described hereinabove, and hence said inorganic particulate fillers are referred to herein as “passive fillers” because they are not capable of direct transport of said metal ion. Nevertheless, such passive fillers have been found surprisingly to enhance the ionic conductivity generated by said first or second metal ion-containing components.

Thus, in a preferred embodiment of the first aspect of the invention, there is provided an electrode constituted by an active material and a binder material, wherein the binder material comprises a copolyester which comprises repeating units derived from a diol, a dicarboxylic acid and a poly(alkylene oxide), and wherein the binder material further comprises a passive filler.

In a further preferred embodiment of the first aspect of the invention, there is provided an electrode constituted by an active material and a binder material, wherein the binder material comprises a copolyester which comprises repeating units derived from a diol, a dicarboxylic acid and a poly(alkylene oxide), wherein the binder material further comprises a first metal ion-containing component selected from conductive ceramic particulate materials and a passive filler.

In a further preferred embodiment of the first aspect of the invention, there is provided an electrode constituted by an active material and a binder material, wherein the binder material comprises a copolyester which comprises repeating units derived from a diol, a dicarboxylic acid and a poly(alkylene oxide), wherein the binder material further comprises a first metal ion-containing component selected from conductive ceramic particulate materials, a passive filler, and additional metal ions from one or more sources other than said conductive ceramic particulate material and other than said passive filler.

Inorganic particulate fillers have routinely been added into polyester films in order to improve handling and windability during manufacture and downstream processing, and for such purposes the fillers are typically used in relatively minor amounts, generally such that the total weight of filler is not more than about 2.5%, preferably not more than about 2.0%, preferably not more than about 1.0%, more typically no more than about 0.6% and preferably no more than about 0.3% by weight, based on the total weight of the copolyester film. However, in the present invention, the passive filler is preferably used in amounts of at least 5 wt %, preferably at least about 7 wt %, preferably at least about 10 wt %, and preferably from about 5 wt % to about 20 wt %, preferably from about 7 wt % to about 20 wt %, preferably from about 7 wt % to about 15 wt %, by total weight of the binder material.

The binder material is preferably present in an amount of from about 0.1 to about 25 wt %, preferably from about 0.2 to about 20 wt %, preferably from about 0.4 to about 10 wt %, preferably from about 0.5 to about 7 wt %, preferably from about 1 wt % to about 6 wt %, preferably from about 2 to about 5 wt % by total weight of the electrode.

As used herein, the term “active material” means an electrochemically active material, which is able to store metal-ions (preferably lithium-ions in a lithium-ion battery) and release them reversibly in a controlled manner. Any suitable electrochemically active material may be used.

It will be appreciated that, whilst the binder material may have some electrochemical activity, the active material is a different entity from the binder material described hereinabove. The active material is also a different entity from each of the copolyester, first metal ion-containing component and second metal ion-containing component described hereinabove.

Where the electrode is an anode, the active material is preferably selected from graphite and/or lithium titanate (LTO).

Where the electrode is a cathode, the active material is preferably selected from lithium or mixed oxides of lithium and other metal(s), particularly lithium titanate (LTO), lithium iron phosphate (LiFePO₄, also known as LFP) and/or lithium-nickel-manganese-cobalt oxide (LiNiMnCoO₂, also known as NMC).

The active material is preferably in particulate form.

The active material is preferably present in an amount of from about 75 to about 99.1 wt %, preferably from about 80 to about 95 wt % by total weight of the electrode. Where the electrode is an anode, the active material is preferably present in an amount of from about 90 to about 95 wt % by total weight of the electrode, for example about 93 wt % by total weight of the electrode.

The active material and the binder material (constituted by the copolyester and, where present, the first metal ion-containing component and/or the second metal ion component) are the major component of electrode, and preferably make up at least about 75%, preferably at least about 80%, preferably at least about 85%, preferably at least about 90%, preferably at least about 95%, and preferably at least about 98% by weight of the total weight of the electrode.

The electrode of the present invention may be further constituted from a conductive additive, such as carbon materials. Thus, carbon materials such as carbon black (e.g., acetylene black) or graphite may be incorporated as appropriate. A particularly preferred carbon black is commercially available as Super-P (Timcal Co., Ltd.). The conductive additive may be present in an amount of from about 0.5 to about 10 wt %, preferably from about 1 to about 6 wt %, preferably from about 2.5 to about 5 wt % by total weight of the electrode.

As discussed hereinabove, the electrode may be derived from a composition comprising the active material, the binder material and a liquid vehicle. Suitable liquid vehicles include N-methyl-2-pyrrolidone (NMP), acetonitrile (ACN), tetrahydrofuran (THF), dimethylformamide (DMF), dimethyl sulfoxide (DMSO), dimethyl carbonate (DMC), ethylene carbonate (EC), propylene carbonate (PC), dimethoxyethane (DME), methyl formate ((MF), nitromethane (NM), diethyl carbonate (DEC), toluene, water, ethanol, acetone, isopropyl alcohol, methanol, ethyal alcohol and ethyal acetate.

The electrode may be a film or a coating. In one embodiment, the electrode is a film. The film may be an oriented film, most preferably a biaxially oriented film. The film may be a self-supporting film or may be cast onto a support base. Preferably, the film is cast onto a support base. In an alternative, preferred, embodiment, the electrode is coated onto a support base. The support base may itself be a component of a solid state battery, such as a current collector or a separator. Where the electrode is coated onto a current collector, the electrode is in electrical contact with the current collector by virtue of being deposited onto the current collector. Where the electrode is coated onto a separator, the electrode has interfacial contact with the separator by virtue of being deposited onto the separator.

According to a second aspect of the invention, there is provided a binder material comprising a copolyester which comprises repeating units derived from a diol, a dicarboxylic acid and a poly(alkylene oxide), and wherein the binder material may further comprises a first metal ion-containing component selected from conductive ceramic particulate materials, and/or may further comprise additional metal ions from one or more sources other than said conductive ceramic particulate materials.

There is also provided the use of a binder material in a composition for forming an electrode, wherein the binder material comprises a copolyester which comprises repeating units derived from a diol, a dicarboxylic acid and a poly(alkylene oxide), and wherein the binder material may further comprises a first metal ion-containing component selected from conductive ceramic particulate materials, and/or may further comprise additional metal ions from one or more sources other than said conductive ceramic particulate materials.

The preferences and elements described in respect of the first aspect apply equally to the second aspect.

According to a third aspect of the invention, there is provided a method for manufacturing an electrode as described in the first aspect herein, wherein said method comprises the steps of:
(i) reacting said diol with said dicarboxylic acid or an ester thereof (suitably a lower alkyl (C₁₋₄) ester, preferably the dimethyl ester), to form a bis(hydroxyalkyl)-ester of said dicarboxylic acid;
(ii) polymerising in a polycondensation reaction said bis(hydroxyalkyl)-ester of said dicarboxylic acid in the presence of an poly(alkylene oxide) to form a copolyester;
(iii) optionally incorporating said first metal ion-containing component selected from conductive ceramic particulate materials, and optionally said additional metal ions from one or more sources other than said conductive ceramic particulate materials, during synthesis of the copolyester in steps (i) and/or (ii), and/or during a subsequent separate step of compounding or mixing with said copolyester,
(iv) providing the copolyester product from step (ii) or (iii) as a binder material;
(v) mixing said active material and said binder material to form a composition;
(vi) forming an electrode from said composition, preferably by solvent-casting a dispersion or solution comprising said composition.

The copolyesters described herein can be synthesised according to conventional techniques for the manufacture of polyester materials. Thus, the copolyester may be made by a first step of direct esterification or trans-esterification, followed by a second step of polycondensation. In the direct esterification embodiment, the diol and dicarboxylic acid are reacted directly, typically under elevated temperature (typically about 150 to 260° C.) and pressure (typically about 40 psi) in the presence of a base (e.g. sodium hydroxide), and with the water by-product of the direct esterification reaction being distilled off, to form a bis(hydroxyalkyl)carboxylate. Once the direct esterification reaction is complete, a stabiliser (e.g. phosphoric acid) is added to neutralise the base. In an alternative embodiment, the copolyester is prepared by the trans-esterification route, which preferably comprises heating an ester of the dicarboxylic acid (suitably a lower alkyl (C₁₋₄) ester, preferably the dimethyl ester) with a molar excess of the diol at elevated temperature (typically in the range of about 150 to 260° C.) in the presence of a basic esterification catalyst (e.g. manganese (II) acetate tetrahydrate, Mn(OAc)₂·4H₂O), and with the methanol by-product of the trans-esterification reaction being distilled off, to form a bis(hydroxyalkyl)carboxylate. Polymerisation is effected in a polycondensation step which is conducted using an appropriate catalyst, usually antimony trioxide, at elevated temperature (typically about 290° C.) and typically under reduced pressure (for instance about 1 mm Hg), with continuous distillation of by-product(s). The poly(alkylene oxide) may be present at the start of the synthetic procedure, since the dicarboxylic acid or dicarboxylic acid ester starting material typically reacts selectively with the diol rather than the poly(alkylene oxide), particularly as the molecular weight of the poly(alkylene oxide) increases. Preferably, however, the poly(alkylene oxide) is added at the start of the polycondensation step.

Preferably, the synthetic procedure further comprises a solid phase polymerisation (SSP) step to increase the molecular weight of the copolyester and increase and/or complete the polymerisation of the poly(alkylene oxide) into the copolyester.

Thus, the product of the polycondensation reaction (step (ii)) is preferably subjected to an SSP step. The solid phase polymerisation may be carried out in a fluidised bed, e.g. fluidised with nitrogen, or in a vacuum fluidised bed, using a rotary vacuum drier. Suitable solid phase polymerisation techniques are disclosed in, for example, EP-A-0419400 the disclosure of which is incorporated herein by reference. Thus, SSP is typically conducted at a temperature which is 10-50° C. below the crystalline melting point (T_{M}) of the polymer but higher than the glass transition temperature (T_{g}) (or where the copolyester exhibits multiple glass transition temperatures, higher than the highest glass transition temperature). An inert atmosphere of dry nitrogen or a vacuum is used to prevent degradation. In a preferred embodiment, solid phase polymerisation is carried out over 16 hours at 220° C. under vacuum.

The optional first metal ion-containing component and optional second metal ion-containing component may be introduced into the copolyester independently or together. When introduced independently, the first metal ion-containing component and second metal ion-containing component may be introduced simultaneously or sequentially. Where either or both of the first and second metal ion-containing component(s) contain a plurality of different compounds, said plurality of compounds may be introduced into the copolyester independently or together, and when introduced independently they may be introduced simultaneously or sequentially.

In one embodiment, referred to herein as Embodiment A1, the first and second metal ion-containing components are introduced into the copolyester during synthesis of the copolyester in steps (i) and/or (ii). Preferably, the first and second metal ion-containing components are added to one or more of the reactant(s) or reaction mixture at the start of the synthetic procedure. Alternatively, the first and second metal ion-containing components are added to the reaction product of the direct esterification or trans-esterification step (i), and before the polymerisation stage (ii).

In a second embodiment, referred to herein as Embodiment A2, the first and second metal ion-containing components are introduced into the copolyester during a separate compounding or mixing step.

In a third embodiment, referred to herein as Embodiment A3, the first and second metal ion-containing components are introduced into the copolyester during different steps. For instance, the second metal ion-containing component is introduced during synthesis of the copolyester in steps (i) and/or (ii) (and preferably added to one or more of the reactant(s) or reaction mixture at the start of the synthesis) and the first metal ion-containing component is introduced during a separate compounding or mixing step.

The electrode may be formed by conventional solvent casting techniques well-known in the art. In general terms, the process comprises forming a dispersion comprising said binder material, said active material and a liquid vehicle. Suitable liquid vehicles include N-methyl-2-pyrrolidone (NMP), acetonitrile (ACN), tetrahydrofuran (THF), dimethylformamide (DMF), dimethyl sulfoxide (DMSO), dimethyl carbonate (DMC), ethylene carbonate (EC), propylene carbonate (PC), dimethoxyethane (DME), methyl formate ((MF), nitromethane (NM), diethyl carbonate (DEC), toluene, water, ethanol, acetone, isopropyl alcohol, methanol, ethyal alcohol and ethyal acetate.

The type of mixing vessel, duration of the dispersion step and temperature of the dispersion step will vary depending on the type of copolyester and liquid vehicle used. Typically, the temperature used is between about 22° C. and about 100° C. Typically, the duration of the dispersion step will be several hours, for example between about 6 hours and 48 hours, between about 10 hours and 30 hours, between about 12 hours and 24 hours.

The optional first metal ion-containing component and optional second metal ion-containing component may already be present in the copolyester which is contacted with the liquid vehicle to form said dispersion. Alternatively, the first and second metal ion-containing components may be mixed with the copolyester dispersion, and in this embodiment said first and second metal ion-containing components may be introduced to said dispersion independently or together. When introduced independently, the first and second metal ion-containing components may be introduced simultaneously or sequentially. Where either or both of the first and second metal ion-containing components contain a plurality of different compounds, said plurality of compounds may be introduced independently or together, and when introduced independently they may be introduced simultaneously or sequentially.

The active material may be introduced to said dispersion independently or together with the components of the binder material. Where the active material contains a plurality of different compounds, said plurality of compounds may be introduced independently or together, and when introduced independently they may be introduced simultaneously or sequentially.

Thus, a composition comprising an active material and a binder material is formed.

The composition is then cast into a film or coated onto a support base. The cast film or coating is then suitably dried in order to remove residual solvent. Typically, the cast film or coating is dried at a temperature of from about 50° C. to about 170° C., preferably from about 80° C. to 160° C. It will be appreciated that the drying step may comprise multiple (e.g. at least two) drying steps across different temperature zones in order to reduce the amount of residual solvent. Once dried, the cast film may be removed from the support base for subsequent processing, and incorporated into the battery as an electrode.

In a particularly preferred method of manufacture, the composition is cast or coated onto a support base which itself is a component of the battery and is in particular a current collector or a separator, i.e. the electrode is formed in situ during battery manufacture. Thus, in a preferred embodiment, the electrode of the battery is formed in situ by casting the electrode composition onto a current collector during battery manufacture. In that case, the composite structure of electrode and current collector then undergoes subsequent processing to manufacture the battery. In an alternative embodiment, the electrode of the battery is formed in situ by casting the electrode onto a separator during battery manufacture. In that case, the composite structure of electrode and separator then undergoes subsequent processing to manufacture the battery.

The present invention further provides an electrode made by the method of the third aspect.

The preferences and elements described in respect of the first to second aspects apply equally to the third aspect.

According to a fourth aspect of the invention, there is provided an assembly comprising a current collector and an electrode, wherein said electrode is the electrode as described in the first aspect or the electrode obtained from the method of the third aspect.

It will be appreciated that the electrode may be deposited onto a surface of the current collector, for example by casting or coating the composition from which the electrode is derived directly onto a surface of the current collector.

Any suitable current collector (such as any suitable anode current collector and/or cathode current collector) may be used.

Suitable anode and/or cathode current collectors are disclosed in, for example, UK application no. 2106834.1, the disclosure of which is incorporated herein by reference. In particular, said anode current collector and/or said cathode current collector may be independently selected from current collectors comprising a biaxially oriented polymeric substrate layer (preferably wherein the polymeric substrate layer is polyester, preferably PET or PEN) and a first metal layer on a side of the polymeric substrate layer, wherein the polymeric substrate layer exhibits positive thermal expansion (preferably from greater than 0% to no more than 3.0%, preferably from 0.1% to 2.0%, preferably from 0.2% to 1.5%) in air at 200° C. in each of the transverse direction (TD) and machine direction (MD), wherein the polymeric substrate layer has a thickness of no more than 12 μm (preferably 1.0 to 12.0 μm, preferably 2.0 to 8.0 μm, preferably 4.0 to 8.0 μm, preferably 4.0 to 6.0 μm), and wherein the first metal layer has a thickness of no more than 1000 nm, and preferably wherein the current collector further comprises a second metal layer, wherein the first metal layer and the second metal layer are on opposing sides of the polymeric substrate layer and wherein the second metal layer independently has a thickness of no more than 1000 nm. Preferably, the thickness of the first metal layer and, where present, the second metal layer is each independently from 50 nm to 1000 nm, preferably from 100 nm to 1000 nm, preferably from 100 nm to 800 nm, preferably from 150 nm to 700 nm. The first metal layer and, where present, the second metal layer suitably each independently exhibits isotropic thermal expansion in air at 200° C. of from greater than 0% to no more than 1.0%, preferably from 0.25% to 0.75%, preferably from 0.3% to 0.5%, preferably wherein the first metal layer and the second metal layer exhibit the same thermal expansion at 200° C. as each other. The first metal layer and, where present, the second metal layer each independently comprise at least one of aluminium, copper, nickel, titanium, silver, nickel-copper alloy, or aluminium-zirconium alloy, and preferably wherein the first and second metal layers are selected from the same material, and preferably wherein the first and second metal layers are both either aluminium or copper. Such current collectors preferably exhibit one or more of the following properties:
(i) an adhesion strength between a metal layer and the polymeric substrate layer of least 600 g/25 mm, preferably at least about 700 g/25 mm, preferably at least about 800 g/25 mm.
(ii) a sheet resistance of from 0.01 Ωsq⁻¹ to 2.0 Ωsq⁻¹ preferably from 0.02 Ωsq⁻¹ to 2.5 Ωsq⁻¹, preferably from 0.02 Ωsq⁻¹ to 2.0 Ωsq⁻¹, preferably from 0.02 Ωsq⁻¹ to 1.5 Ωsq⁻¹, preferably from 0.05 Ωsq⁻¹ to 1.0 Ωsq⁻¹.
(iii) a breakdown current of no more than about 30 A and/or a breakdown temperature of no more than about 300° C.

Such preferred current collectors may be made by a method which comprises the steps of (I) forming a biaxially oriented polymeric substrate layer, and (II) depositing a metal on one or both surfaces of said substrate layer to form a metal layer (preferably using thermal evaporation deposition, electron beam evaporation deposition or virtual cathode deposition). Preferably step (I) comprises the following stages, in order:
(1) extruding a layer of molten polymer, subjecting the extrudate to biaxial stretching at a temperature above the glass transition temperature(s) of the polymer, preferably wherein said biaxial stretching is simultaneous biaxial stretching, and preferably stretching is effected so that the dimension of the oriented film is 2 to 5 times its original dimension in each direction of stretching;
(2) dimensionally stabilising a biaxially stretched film by annealing under dimensional support at a temperature above the glass transition temperature(s) of the polymer but below the melting temperature (T_{M}) thereof, preferably wherein the annealing temperature is in the range of from T_{M}-80° C. to T_{M}−10° C., and preferably in the range of from 200 to 245° C., preferably in the range of from 220 to 240° C.;
(3) subjecting an annealed biaxially stretched film to dimensional relaxation, preferably simultaneous dimensional relaxation, in both the transverse direction and machine direction, and wherein the degree of relaxation is from 0.5 to 5.0%, preferably from 1.0 to 4.0%, preferably from 1.0 to 3.0%, preferably from 1.0 to 2.0% in each of the transverse and machine directions, preferably wherein the degree of relaxation in the machine and transverse directions are the same, preferably wherein the temperature of the relaxation step is no higher than that of a preceding annealing step, and preferably from 200° C. to 240° C., preferably from 210° C. to 230° C., preferably from 215° C. to 230° C.;
(4) optionally a second relaxation step which is conducted at a lower temperature than the preceding relaxation step, preferably at least 5° C. lower, and preferably in the range of from 195° C. to 230° C., preferably from 195° C. to 220° C.
(5) optionally subjecting an exposed surface of the polymeric substrate layer to a surface-modifying treatment, wherein said treatment step occurs after step (I) and prior to step (II), preferably wherein said treatment comprises subjecting the exposed surface of the polymeric substrate layer to a plasma treatment, preferably corona discharge.

It will be appreciated that the term “metal” in the metal layers of said preferred current collectors is used in a context which is distinct and independent from the use of the term “metal” as used in the context of the electrodes and batteries in the remainder of the present disclosure. In particular, the identity of the metal layer in a current collector is independent from the identity of the metal ions in the electrode and the identity of the metal-ion battery (i.e. whether the metal ion battery is a lithium ion battery or a sodium ion battery etc.).

The preferences and elements described in respect of the first to third aspects apply equally to the fourth aspect.

According to a fifth aspect of the invention, there is provided an assembly comprising a separator and an electrode, wherein said electrode is the electrode as described in the first aspect or the electrode obtained from the method of the third aspect.

Any suitable separator may be used.

Preferred separators are disclosed in, for example, WO-2019/186173-A1, WO-2021/064359-A1 and UK application no. 2110926.9, the disclosures of which are incorporated herein by reference. In particular, said separator may be a copolyester film comprising a copolyester which comprises repeating units derived from a diol, a dicarboxylic acid and a poly(alkylene oxide), wherein the copolyester film further comprises a first metal ion-containing component selected from conductive ceramic particulate materials, and wherein the film may further comprise additional metal ions from one or more sources other than said conductive ceramic particulate material.

Such preferred separators may be made by a method which comprises manufacturing the copolyester film, wherein said method comprises the steps of:
(i) reacting said diol with said dicarboxylic acid or an ester thereof (suitably a lower alkyl (C₁₋₄) ester, preferably the dimethyl ester), to form a bis(hydroxyalkyl)-ester of said dicarboxylic acid;
(ii) polymerising in a polycondensation reaction said bis(hydroxyalkyl)-ester of said dicarboxylic acid in the presence of an poly(alkylene oxide) to form a copolyester;
(iii) introducing said first metal ion-containing component selected from conductive ceramic particulate materials, and optionally said additional metal ions from one or more sources other than said conductive ceramic particulate materials, during synthesis of the copolyester in steps (i) and/or (ii), and/or during a subsequent separate compounding or mixing step, to form a copolyester composition; and
(iv) forming a copolyester film from said copolyester composition, preferably by melt-extruding said composition or by solvent-casting a dispersion or solution comprising said copolyester composition.

The separator may be synthesised according to the techniques disclosed in UK application no. 2110926.9, the disclosures of which are incorporated herein by reference. In particular, the film-forming copolyester composition may be cast onto a support base which itself is a component of the battery and in particular is an electrode as described herein, i.e. the cast film is formed in situ during battery manufacture. This method of manufacture is of particular utility in the solvent-casting method, but is not limited thereto and may also be used for an extrusion method of film formation. Thus, in this embodiment, the separator of the battery is formed in situ by casting the copolyester film onto the electrode during battery manufacture. In that case, the composite structure of electrode and cast copolyester film then undergoes subsequent processing to manufacture the battery.

Advantageously, it has been found that where this is the case, a continuous coating on the electrode of the present invention can be obtained which, in use, ultimately leads to effective interfacial compatibility and contact between the separator and the electrode. Not only is the contact between the separator and the electrode excellent immediately after the separator has been disposed onto the separator but it has also been found to remain excellent even after use.

Where conventional electrodes are used, then problems with coverage of the copolyester film on the electrode occur, which results in a discontinuous coating which, in turn, leads to poor interfacial compatibility and contact between the separator and the electrode.

The preferences and elements described in respect of the first to fourth aspects apply equally to the fifth aspect.

According to a sixth aspect, there is provided a metal-ion battery (particularly a lithium-ion battery) comprising an anode, a cathode, a separator, an anode current collector and a cathode current collector, such that the layer order is anode current collector/anode/separator/cathode/cathode current collector, and wherein at least one of the anode and cathode is the electrode as described herein.

Preferably, the metal-ion battery is a solid-state battery (also referred to herein as a dry-cell battery). Alternatively, the metal-ion battery further comprises a liquid or gel electrolyte, typically referred to in the art as a wet-cell battery. It will be appreciated by those skilled in the art that the metal-ion battery is a rechargeable battery.

Any suitable anode, anode current collector, separator, cathode, cathode current collector and electrolyte as conventional in the art and as described herein, may be used.

Where the metal-ion battery is a solid-state battery, preferably at least one of the anode and cathode is the electrode as described herein wherein the binder material comprises a copolyester which comprises repeating units derived from a diol, a dicarboxylic acid and a poly(alkylene oxide), and wherein the binder material further comprises a first metal ion-containing component selected from conductive ceramic particulate materials and further comprises additional metal ions from one or more sources other than said conductive ceramic particulate materials.

Where the metal-ion battery is a wet-cell battery, in one embodiment, at least one of the anode and cathode is the electrode as described herein wherein the binder material comprises a copolyester which comprises repeating units derived from a diol, a dicarboxylic acid and a poly(alkylene oxide), wherein the binder material does not comprise a first metal ion-containing component selected from conductive ceramic particulate materials and additional metal ions from one or more sources other than said conductive ceramic particulate materials. It will be appreciated that, in this embodiment, the electrode does not comprise metal ions prior to assembly of the wet-cell battery. However, during use and operation of the wet-cell battery, the metal ions present in the electrotype are mobile, enabling the required conductivity. Thus, during use and operation of the wet-cell battery, the metal ions saturate the electrode. In other words, during use and operation of the wet-cell battery, the electrode further comprises metal ions.

The preferences and elements described in respect of the first to fifth aspects apply equally to the sixth aspect.

According to a seventh aspect there is provided the use of the electrode as described herein as an electrode in a battery, preferably in a metal-ion battery, preferably in a lithium-ion battery.

The preferences and elements described in respect of the first to sixth aspects apply equally to the seventh aspect.

According to an eighth aspect of the invention, there is provided a method of manufacturing a metal-ion battery comprising the electrode as described herein, the method comprising the steps of:
(a) providing the electrode as described herein;
(b) assembling the metal-ion battery, wherein the battery comprises an anode, a cathode, a separator, an anode current collector and a cathode current collector, such that the layer order is anode current collector/anode/separator/cathode/cathode current collector, and wherein at least one of the anode and cathode is the electrode as described herein.

The preferences and elements described in respect of the first to seventh aspects apply equally to the eighth aspect.

### Property Measurement

The following test methods were used to characterise the properties of the copolyesters, electrodes and batteries described herein.

(i) Glass Transition Temperature (T_{g}), Crystalline Temperature (Tₑ) and Crystalline Melting Point (Tₘ)
These thermal parameters were measured by differential scanning calorimetry (DSC) using a PerkinElmer HyperDSC 8500. Unless otherwise stated, measurements were made according to the following standard test method and based on the method described in ASTM E1356-98. The sample was maintained under an atmosphere of dry nitrogen for the duration of the scan. A flow rate of 20 ml min⁻¹ and Al pans were used. Samples (5 mg) were initially heated at 20° C. min⁻¹ from 20° C. to 350° C. in order to erase the previous thermal history (1^{st} heating scan). After an isothermal hold at 350° C. for 2 min, samples were cooled at 20° C. min⁻¹ to 20° C. (1^{st} cooling scan). Samples were then reheated at 20° C. min⁻¹ to 350° C. (2^{nd} a heating scan). Values of T_{g} and T_{M} were obtained from 2^{nd} heating scans. As is well known, the glass transition temperature of a polymer is the temperature at which it changes from a glassy, brittle state to a plastic, rubbery state. The value of a T_{g} was determined as the extrapolated onset temperature of the glass transition observed on the DSC scans (heat flow (W/g) against temperature (° C.)), as described in ASTM E1356-98. It will be appreciated that the copolyesters of the present invention may be associated with two T_{g} values, one T_{g} for the soft segments and one T_{g} for the hard segments. The values of T_{c} and Tₘ were determined from the DSC scans as the peak exotherm or endotherm of the transition.

### (ii) Melt Viscosity

The term “melt viscosity” as used herein means the complex viscosity of a polymer measured at a particular melt temperature and a particular frequency of oscillation. The complex viscosity was measured by rotational rheology testing using a TA Instruments DHR-1 according to the following test method. Polymer samples (2.5 g) were dried under dynamic vacuum at 140° C. for 16 h. The samples were then held between 2×25 mm diameter parallel plates and heated to the required temperature under a nitrogen atmosphere. Analysis of the complex viscosity of the polymer was performed via a temperature ramp method, whereby samples were heated at a rate of 4° C. min-1, at constant strain (5%) and angular frequency (10 rad s⁻¹).
   (iii) Bulk Resistance and Through-Film Ionic Conductivity of the Preferred Separator (Dry Cell Setup (Solid State))
The through-film ionic conductivity of film samples with no additional electrolyte present, i.e. in the dry cell setup (solid state), was determined by Electrochemical Impedance Spectroscopy (EIS). Dry coin cells having a diameter of 12 mm were constructed. Symmetric Al/Al dry coin cells with 1×1 mm spacers were constructed at a dew point of <40° C. in an argon glove box. AC impedance spectra were obtained using a AutoLab unit under open circuit voltage (OCV) in the AC frequency range from 100 MHz to 1 MHz at an operating temperature of the battery (within the range of about 25° C. and about 75° C., and at ambient temperature (25° C.) unless otherwise specified) following a perturbation voltage of 10 mV. A Nyquist impedance plot was generated and the x-axis intercepts used to calculate resistance values (in ohms) for the resistance R₁ of the coin cell components (in ohms) and the bulk resistance R₂ of the separator (it will be appreciated that the separator has the relatively higher resistance value of the two values generated form the Nyquist plot). The through-film ionic conductivity (a) of the film separator was calculated from the bulk resistance R₂ using the formula:

$$σ = \frac{1}{{R}_{2}} \frac{d}{A}$$

where d is the film sample thickness (in cm) and A is the area of the film (in cm²) contacting the electrodes. It will be appreciated that the area of the film refers to the total film area, i.e. the total area of both sides of the film contacting the Al electrodes. The ionic conductivity is expressed in Siemens/cm, usually in the form of its logarithm (base 10).

### (iv) Molecular Weight (M_{N})

GPC measurements were performed on a Malvern/Viscotek TDA 301 using an Agilent PL HFIPgel guard column plus 2×30 cm PL HFIP gel columns. A solution of HFIP with 25 mM NaTFAc was used as eluent, with a nominal flow rate of 0.8 mL min⁻¹. All experimental runs were conducted at 40° C., employing a refractive index detector. Molecular weights are referenced to polymethylmethacrylate calibrants. Data capture and subsequent data analysis were carried out using Omnisec software. Samples were prepared at a concentration of 2 mg mL⁻¹, with 20 mg of sample dissolved in 10 mL eluent. These solutions were stirred for 24 h at room temperature and then warmed at 40° C. for 30 mins to fully dissolve the polymer. Each sample was filtered through a 0.45 m polytetrafluoroethylene membrane prior to injection. Determination of M_{W} may also be made using such a measurement. Once the M_{W} and M_{N} values are known, the PDI may be determined.

### (v) Level of Poly(Alkylene Oxide) in the Copolyester

1H NMR spectroscopy was used to determine the level of poly(alkylene oxide) in the copolyester, using an ECS400 spectrometer at 80° C., referenced to residual solvent (d₂-TCE (1,1,2,2-tetrachloroethane)) resonances.

### (vi) Expansion of the Biaxially Oriented Polymeric Layer (of the Preferred Current Collector)

A sample of the biaxially oriented polymeric layer of the preferred current collector having dimensions of 5 mm×8 mm was subjected to thermomechanical analysis using a thermomechanical analyser (TMA Q400 by TA Instruments Inc.). The longer dimension of the sample (i.e. the 8 mm dimension) corresponds to the sample direction for which expansion was being tested. The sample was mounted on the apparatus and the sample was subjected in the machine direction (MD) or in the transverse direction (TD) to a load of 1 N/mm² and a temperature increase rate of 10° C./min from 32° C. to 220° C. The thermal expansion in air at a temperature of 200° C. was measured. The thermal expansion in air at 200° C. is defined as the % change of dimension of the film in the given direction (i.e. in the MD or TD), and calculated as (L₁−L₀)/L₀×100, where L₀ is the dimension at 32° C. and Li is the dimension at 200° C. As the skilled person will appreciate, a negative thermal expansion indicates thermal shrinkage.
   (vii) Sheet Resistance (of the Preferred Current Collector)

The sheet resistance of the conductive layer of the preferred current collector was measured using a linear four point probe (Jandel Model RM2) according to ASTM F390-98 (2003).

(viii) Breakdown Current and Temperature at Breakdown (of the Preferred Current Collector)
A current collector sample having dimensions 50 mm×10 mm was held at each end between a pair of conducting clamps. The sample was clamped such that 10 mm² at each end of the sample was held within the clamps. A current was passed through the samples at a ramp rate of 2 A/min until breakdown was observed. The temperature profile of the sample was monitored using a thermal imaging camera throughout the test, in order to determine the temperature at breakdown.

### (IX) Adhesion Strength (of the Preferred Current Collector)

The adhesion strength of the metallised polymeric substrate to an EAA (ethylene acrylic acid film) having a thickness of 25 μm (available commercially as Vistafix(TP) from UCB Sidac Division) was assessed as follows. A sample of the current collector and a sample of the EAA film were positioned together such that the outer surface of the metallised polymeric substrate layer was contacted with the surface of the EAA film. The samples were heat-sealed using a Sentinel Model 12 (Packaging Industries Group Inc) machine under the following conditions: 105° C. (top jaw) and 25° C. (lower jaw) for 10 seconds under a pressure of 50 psi. The sealed sample was cut into 25 mm wide strips and the adhesion strength was determined using an Instron Model 4464. The jaws were set 50 mm apart. The upper jaw held the EAA piece of the sealed sample and travelled up at a speed of 300 mm/min, while the lowerjaw held the current collector piece of the sealed sample and was stationary. The average peel force was measured and reported as a mean value of 5 results. The plane of adhesion failure was also noted. When the adhesion strength between the metal layer and the polymeric substrate layer is lower than the adhesion strength (about 800 g/25 mm) between the metal layer and the EEA film, the test sample delaminates along the interface of the metal layer and polymeric substrate layer. In this case, the average peel force represents the adhesion strength between the metal layer and the polymeric substrate layer. When the adhesion strength between the metal layer and the polymeric substrate layer is higher than the adhesion strength (800 g/25 mm) between the metal layer and the EEA film, the test sample delaminates along the interface of the metal layer and EEA film. A further plane of failure is coherent failure within the metallised layer itself, which also indicates that the adhesion strength between the metal layer and the polymeric substrate layer is greater than the force required to achieve coherent failure (typically the adhesion strength between the metal layer and the polymeric substrate layer is therefore greater than about 800 g/25 mm).

The present invention is further illustrated with reference to the following non-limiting examples.

### EXAMPLES

In the following discussion, reference to “LICGC” is to a lithium-ion conducting glass ceramic powder available commercially from Ohara under the tradename LICGCTh PW-01, and reference to “PEG3350” is to a polyethylene glycol having a number average molecular weight (M_{N}) of 3350.

### Experiment 1

In the examples, an assembly was prepared which included an electrode, a current collector and a separator, such that the layer order was separator/electrode/current collector.

Specifically, an aluminium current collector foil was obtained. An electrode was prepared and cast on a surface of the current collector, as detailed in the specific examples below. A separator film comprising a copolyester, LICGC and LiCF₃SO₃ was then prepared and cast on the opposing surface of the electrode as follows.

The copolyester was made using bis(2-hydroxyethyl) isophthalate (BHEI) and polyethylene glycol (PEG 3350). PEG 3350 was present at a level of 50 wt % of the copolyester. The copolyester was made by reacting 49.82 g BHEI and 50.18 kg PEG 3350 along with the addition of an antioxidant (Irganox® 1010, 2.95 g). Polycondensation was effected with an antimony trioxide catalyst (0.20 g) at about 280-290° C., and wherein the pressure above the melt was reduced to less than 5 mm Hg. As the polycondensation reaction proceeded, the viscosity of the batch increased, and once a pre-determined viscosity had been achieved the polymerisation reaction was stopped by restoring the pressure in the vessel back to atmosphere. The copolyester was then extruded as a lace, cast into a water bath and dried. A solvent-cast copolyester film was made by dissolving 0.4 g of the copolyester in 5 mL NMP with 0.1 g of LiCF₃SO₃ and 0.5 g of LICGC. The components were dispersed and thoroughly mixed in the NMP in a beaker at 25° C. for 12 hours to provide a copolyester composition. The separator film was made by solvent-casting the copolyester composition on the surface of the electrode and dried by heating at 60° C. for 24 hours, and then vacuum-dried at 60° C. for a further 24 hours to provide the separator film having a thickness of 82 μm. The uniformity of the coverage of the separator film on the electrode was assessed.

### Comparative Example 1

An electrode was derived from a composition made by mixing lithium titanate (LTO) as the active material, polyvinylidene fluoride (PVDF), a Li salt and LiCGC.

The composition was cast on an aluminium current collector foil. The resultant product was then dried, thereby forming an electrode.

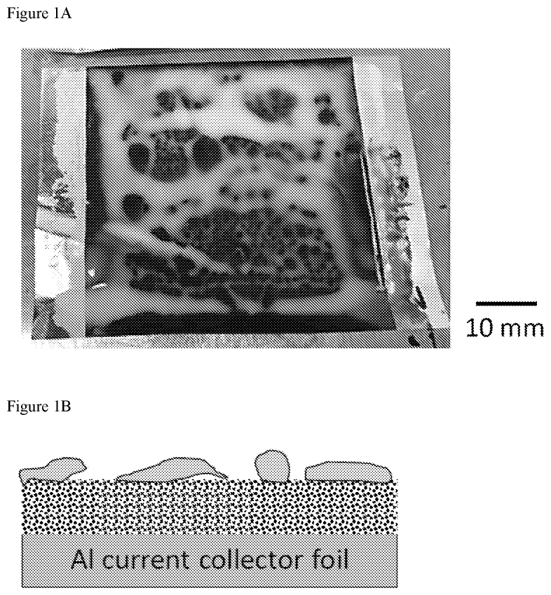

The separator material was then cast on the electrode as described above. The result is shown in FIG. 1, which shows that the separator did not achieve continuous film coverage over the electrode surface.

Instead, only partial coverage was observed and interfacial compatibility and contact between the electrode and the separator was poor.

### Example 1

An electrode was derived from a composition made by mixing lithium titanate (LTO) and the copolyester composition described above in relation to the separator material (i.e. the composition including the copolyester, LiCF₃SO₃ and LICGC dispersed and thoroughly mixed in NMP).

The composition was cast on an aluminium foil. The resultant product was then dried, thereby obtaining an electrode.

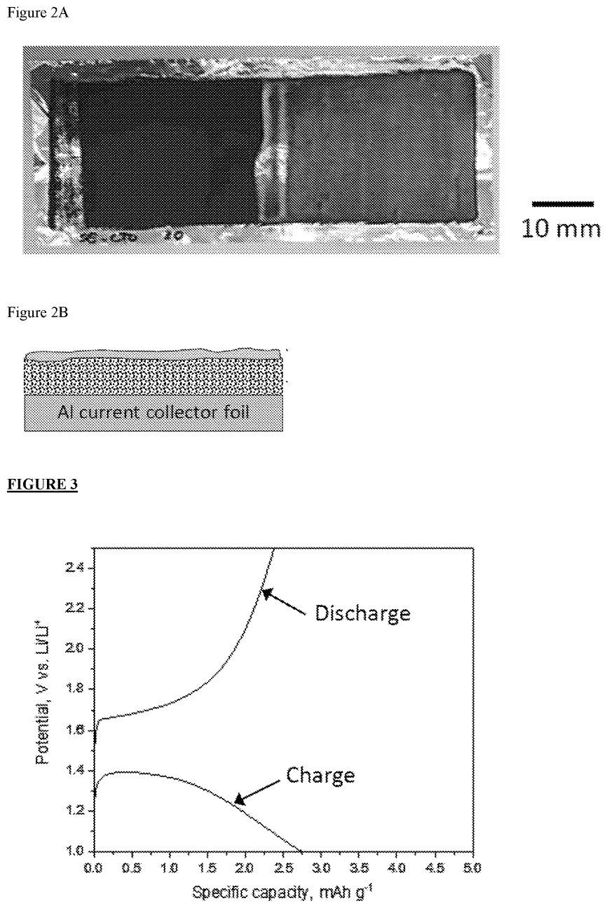

The separator material was then cast on the electrode as described above. The result is shown in FIG. 2, which shows that the separator achieved continuous and uniform film coverage over the entire electrode surface. The interfacial compatibility and contact between the electrode and the separator was excellent.

### Experiment 2

A solid-state cell battery was prepared using the separator, cathode and cathode current collector of Example 2. A lithium foil was used as the anode and was contacted with the separator surface, such that the layer order is: lithium foil anode/separator/cathode/aluminium foil cathode current collector.

The battery characteristics were assessed. The bulk resistance was 5.6 kΩ. FIG. 3 presents the electrode potential as a function of the specific capacity. As shown in FIG. 3, the battery was able to charge and discharge effectively.

1. An electrode constituted by an active material and a binder material, wherein the binder material comprises a copolyester which comprises repeating units derived from a diol, a dicarboxylic acid and a poly(alkylene oxide), and wherein the binder material may further comprise a first metal ion-containing component selected from conductive ceramic particulate materials, and/or may further comprise additional metal ions from one or more sources other than said conductive ceramic particulate materials.

2. An electrode according to claim 1, wherein said copolyester comprises semi-crystalline segments derived from an dicarboxylic acid and an aliphatic diol, and amorphous segments derived from poly(alkylene oxide).

3. An electrode according to any preceding claim wherein the poly(alkylene oxide) constitutes from about 0.1 to about 80 wt %, preferably from about 5 to about 78 wt %, preferably from about 10 to about 75 wt %, preferably from about 12 to about 65 wt %, preferably from about 15 to about 60 wt %, preferably from about 16 to about 55 wt % by total weight of the copolyester.

4. An electrode according to any preceding claim wherein the diol is selected from C₂, C₃ or C₄ aliphatic diols, preferably wherein the aliphatic diol is ethylene glycol.

5. An electrode according to any preceding claim wherein the dicarboxylic acid is an aromatic dicarboxylic acid selected from isophthalic acid, naphthalene dicarboxylic acid and terephthalic acid.

6. An electrode according to any preceding claim wherein the poly(alkylene oxide) is selected from C₂ to C₁₅, preferably C₂ to C₁₀, preferably C₂ to C₆ alkylene chains, preferably from polyethylene glycol (PEG), polypropylene glycol (PPG) and poly(tetramethylene oxide) glycol (PTMO), preferably from PEG and PPG, preferably wherein the poly(alkylene oxide) is PEG.

7. An electrode according to any preceding claim wherein the number average molecular weight of the poly(alkylene oxide) is from about 200 to about 20000 g/mol, preferably from about 400 to about 3500 g/mol, preferably from about 500 to about 3500 g/mol.

8. An electrode according to any preceding claim wherein the binder material comprises said first metal ion-containing component and/or said additional metal ions, preferably wherein the binder material comprises said first metal ion-containing component and said additional metal ions.

9. An electrode according to any preceding claim, wherein said additional metal ions are in the form of a second metal ion component, preferably selected from metal salts.

10. An electrode according to any preceding claim wherein the metal of said first metal ion-containing component is the same as the metal of said additional metal ions.

11. An electrode according to any preceding claim, wherein said metal is selected from lithium, sodium, potassium, calcium, magnesium and aluminium, preferably from lithium, sodium, magnesium and aluminium, preferably from lithium and sodium, and is preferably lithium.

12. An electrode according to any preceding claim, wherein said metal is lithium and the lithium ion-containing conductive ceramic particulate material is selected from NASICON-type ceramic particulate materials such as lithium ion-containing conductive glass ceramic particulate materials;
LISICON-type ceramic particulate materials; perovskite-type oxide ceramic particulate materials;
garnet-type oxide ceramic particulate materials; lithium phosphorus oxynitride (LIPON)-type ceramic particulate materials; and lithium aluminium silicate (LAS) ceramic particulate materials.

13. An electrode according to any preceding claim, wherein said metal is lithium and the lithium ion-containing conductive ceramic particulate material is selected from:
NASICON-type materials having the general formula LiM_{y}(PO₄)₃, where M denotes a multivalent metal ion such as one or more of Al, Si, Ti, Zr, Ge, Sn and Hf;
NASICON-type materials having the general formula Li₁₊ₓMₓTi₂₋ₓ(PO₄)₃ (LATP) where M denotes a trivalent cation selected from one or more of Al, Sc, Y and La;
NASICON-type materials having the general formula Li₁₊ₓAlₓGe₂₋ₓ(PO₄)₃ (LAGP);
materials having a crystalline phase of Li_{1+x+y}AlₓTi₂₋ₓSi_{y}P_{3-y}O₁₂ and a composition of Li₂O—Al₂O₃—SiO₂—P₂O₅—TiO₂;
materials having a main crystalline phase of Li_{1+x+y}Alₓ(Ti,Ge)₂₋ₓSi_{y}P_{3-y}O₁₂ and a composition of Li₂O—Al₂O₃—SiO₂—P₂O₅—TiO₂—GeO₂;
LISICON-type materials having the general formula Li₂₊₂ₓZn₁₋ₓGeO₄, optionally wherein other elements (typically isovalent elements) may replace the Li, Zn and/or Ge, such as Li₂₊₂ₓZn₁₋ₓGe₄O₁₆, Li₁₄ZnGe₄O₁₆, Li₍₃₊ₓ₎GeₓV₍₁₋ₓ₎O₄, Li₍₄₋ₓ₎Si₍₁₋ₓ₎PₓO₄;
thio-LISICON-type materials such as Li₍₄₋ₓ₎Ge₍₁₋ₓ₎PₓS₄Li₁₀GeP₂S₁₂;
perovskite-type oxide materials such as Li₃ₓLa_{(2/3)-x}TiO₃ (LLTO) and Li₃ₓLa_{1/3-x}TaO₃;
garnet-type oxide materials having the general formula Li_{7-3y-x}La₃Zr₂₋ₓM1_{y}M2ₓO₁₂ (where M1 denotes a trivalent cation such as Al and Ga, M2 denotes a pentavalent cation such as Nb and Ta, x≥0 and y≤2) such as Li₅La₃M₂O₁₂ (where M denotes Nb and/or Ta), Li₆ALa₂M₂O₁₂ (where A denotes Ca, Sr and/or Ba, and M denotes Nb or Ta) or Li_{6.5}La_{2.5}Ba_{0.5}ZrTaO₁₂;
LIPON-type materials having the general formula LiₓPO_{y}N_{z}, such as Li₂PO₂N; and
LAS-type materials such as AlLiO₆Si₂.

14. An electrode according to any of claims 1 to 12, wherein said metal is sodium and the sodium ion-containing conductive ceramic particulate material is selected from NASICON-type materials such as conductive glass ceramic particulate materials, beta-alumina and beta”-alumina phases Na₂O·nAl₂O₃ where 5≤n≤11, sodium rare earth silicates, and sodium-ion conducting oxyhalide glasses; and preferably from NASICON-structured oxides having the general formula Na₃Zr₂Si₂PO₁₂, NaTi₂(PO₄)₃, NaGe₂(PO₄)₃ or Na₁₊ₓ[SnₓGe₂₋ₓ(PO₄)₃], sodium rare earth silicates having the general formula Na₅MSi₄O₁₂, where M is Y, Sc, Lu and/or any trivalent rare earth cation, and sodium-ion conducting oxyhalide glass such as NaI—NaCl—Na₂O—B₂O₃.

15. An electrode according to any preceding claim wherein the amount of said metal ion-containing conductive ceramic particulate material present in the binder material in the range of from about 0.1 wt % to about 60 wt %, preferably from about 5 wt % to about 50 wt %, preferably from about 8 wt % to about 35 wt %, preferably from about 10 to about 20 wt % by total weight of the binder material.

16. An electrode according to any preceding claim wherein said additional metal ions are in the form of a metal salt selected from salts of:
(i) aromatic carboxylic acids, preferably aromatic dicarboxylic acids, preferably terephthalic acid or isophthalic acid;
(ii) aliphatic carboxylic acids, including aliphatic dicarboxylic acids, preferably acetic acid, glycolic acid or succinic acid;
(iii) carbonic acids;
(iv) phenolic acids, preferably salicylic acid;
(v) mineral acids, such as perchloric acid or phosphoric acid, particularly phosphoric acid; and
(vi) boric acids, preferably bis(oxalate)boric acid.

17. An electrode according to any preceding claim wherein said additional metal ions are in the form of a metal salt of an organic acid, and which is preferably the salt of the aromatic dicarboxylic acid from which the copolyester is derived.

18. An electrode according to claim 16 or 17 wherein said additional metal ions are in the form of a metal salt selected from the alkoxylate esters of said acids, preferably the carboxylic acids, preferably the dicarboxylic acids, preferably the aromatic dicarboxylic acids, preferably terephthalic acid, and wherein said alkoxylate esters are preferably derived from the aliphatic diols, preferably from C₂₋₁₀ aliphatic diols, preferably from C₂₋₆ aliphatic diols, preferably from C₂, C₃ or C₄ aliphatic diols, more preferably from ethylene glycol, 1,3-propanediol and 1,4-butanediol, more preferably from ethylene glycol.

19. An electrode according to any preceding claim wherein said additional metal ions are lithium ions and in the form of lithium salts selected from bis(trifluoromethanesulfonyl)imide (LiTFSI), lithium hexafluorophosphate (LiPF₆), lithium tetrafluoroborate (LiBF₄), lithium thiocyanate (LiSCN), lithium hexafluoroarsenate (LiAsF₆), lithium trifluoromethanesulfonate (LiCF₃SO₃), lithium bromide (LiBr), lithium iodide (LiI), lithium bis(trifluoromethanesulfonimide) (LiN(CF₃SO₂)₂), lithium tris(trifluoromethylsulfonyl)methide (LiC(CF₃So₂)₃), lithium orthosilicate, lithium trifluoroacetate (LiCF₃CO₂), lithium bis(fluorosulfite)amide (LiN(FO₂S)₂), dilithium terephthalate (DLTA), dilithium isophthalate, lithium glycolate, lithium benzoate, lithium acetate, lithium carbonate, lithium perchlorate, lithium orthosilicate, lithium phosphate, lithium salicylate, lithium succinate, lithium bis(oxalato)borate and dilithium bis hydroxy ethyl terephthalate (DL-BHET).

20. An electrode according to any preceding claim wherein said additional metal ions are lithium ions and in the form of lithium salts selected from dilithium terephthalate (DLTA), dilithium isophthalate, dilithium bis hydroxy ethyl terephthalate (DL-BHET) and LiCF₃SO₃.

21. An electrode according to any of claims 1 to 16 wherein said additional metal ions are sodium ions and in the form of sodium salts selected from sodium nitrate (NaNO₃), sodium perchlorate (NaClO₄), sodium tetrafluoroborate (NaBF₄), sodium hexafluorophosphate (NaPFE), sodium bis(trifluoromethanesulfonyl)imide (NaTFSI), sodium bis(trifluoromethane)sulfonimide (Na[N(CF₃SO₂)₂]), sodium hexafluoroarsenate(V) (NaAsF₆), sodium bis(oxalatoborate) (“NaBOB”), sodium halides (NaX), where X═Cl, Br or I, sodium thiocyanate (NaSCN), sodium pentacyanopropenide (NaPCPI), sodium tetracyanopirolate (NaTCP) and sodium tricyanoimidazolate (NaTIM).

22. An electrode according to any preceding claim wherein said additional metal ions are present in and held within the polymeric matrix of the binder material by the interaction between the metal cations and negatively charged oxygen atoms of the copolyester, preferably at least the oxygen atoms of the polyalkylene oxide units.

23. An electrode according to any of claims 1 to 21 wherein said additional metal ions are in the form of a metal salt and held within the polymeric matrix of the copolyester by virtue of the interaction between the metal cations and the anion of said metal salt which is not covalently bound to the copolyester.

24. An electrode according to any preceding claim wherein the amount of said additional metal ions in the film is effective to provide a metal:O molar ratio of from 5:1 to 1:50, preferably from about 4:1 to about 1:50, preferably from about 3:1 to about 1:50, preferably from about 2:1 to about 1:50, preferably about 1:1 to about 1:40, preferably about 1:2 to about 1:30, preferably about 1:4 to about 1:25, wherein the number of O atoms in this ratio is defined as the number of O atoms in the poly(alkylene oxide) residues, and the number of metal atoms in this ratio is defined as the number of metal atoms provided by said additional metal ions.

25. An electrode according to any preceding claim wherein said additional metal ions are in the form of a second metal ion component (preferably metal salts) which is present in the binder material in an amount of from 0.1 wt % to about 40 wt %, preferably from about 1 wt % to about 10 wt % by total weight of the binder material.

26. An electrode according to any preceding claim wherein the binder material further comprises an inorganic particulate filler selected from metalloid oxides such as alumina, titania, zirconia, zinc oxide, talc and silica; calcined china clay; alkaline metal salts such as the carbonates and sulphates of calcium and barium; and non-conductive ceramic particulate materials, wherein said inorganic particulate filler is a different entity from the first and second metal ion-containing components and does not contain the metal ion of the first or second metal ion-containing components, preferably wherein the inorganic particulate filler is present in amounts of from about 5 wt % to about 20 wt %, by total weight of the binder material.

27. An electrode according to any preceding claim, wherein the binder material is present in an amount of from about 0.1 to about 25 wt %, preferably from about 2 to about 5 wt % by total weight of the electrode.

28. An electrode according to any preceding claim, wherein the electrode is an anode and wherein said active materials are selected from graphite and/or lithium titanate (LTO).

29. An electrode according to any preceding claim, wherein the electrode is a cathode and wherein said active materials are selected from lithium or mixed oxides of lithium and other metal(s), particularly lithium titanate (LTO), lithium iron phosphate (LiFePO₄, also known as LFP) and/or lithium-nickel-manganese-cobalt oxide (LiNiMnCoO₂, also known as NMC).

30. An electrode according to any preceding claim, wherein the active materials are present in an amount of from about 75 to about 99.1 wt %, preferably from about 80 to about 95 wt % by total weight of the electrode.

31. An electrode according to any preceding claim which is a film.

32. An electrode according to any preceding claim which is cast onto a support base, preferably wherein the support base is a current collector or a separator.

33. Use of a binder material in a composition for forming an electrode, wherein the binder material comprises a copolyester which comprises repeating units derived from a diol, a dicarboxylic acid and a poly(alkylene oxide), and wherein the binder material may further comprise a first metal ion-containing component selected from conductive ceramic particulate materials, and/or may further comprise additional metal ions from one or more sources other than said conductive ceramic particulate materials.

34. Use of a binder material according to claim 34 wherein the binder material is as described in any of claims 2 to 32.

35. A method for manufacturing an electrode as described in any of claims 1 to 32, wherein said method comprises the steps of:
(i) reacting said diol with said dicarboxylic acid or an ester thereof (suitably a lower alkyl (C₁ 4) ester, preferably the dimethyl ester), to form a bis(hydroxyalkyl)-ester of said dicarboxylic acid;
(ii) polymerising in a polycondensation reaction said bis(hydroxyalkyl)-ester of said dicarboxylic acid in the presence of an poly(alkylene oxide) to form a copolyester;
(iii) optionally introducing said first metal ion-containing component selected from conductive ceramic particulate materials, and optionally said additional metal ions from one or more sources other than said conductive ceramic particulate materials, during synthesis of the copolyester in steps (i) and/or (ii), and/or during a subsequent separate compounding or mixing with said copolyester;
(iv) providing the copolyester product from step (ii) or (iii) as a binder material;
(vi) mixing said active material with said binder material to form a composition;
(vii) forming an electrode from said composition, preferably by solvent-casting a dispersion or solution comprising said composition.

36. A method according to claim 36 wherein said electrode composition is disposed onto a supporting base which is itself a component of a solid state battery, preferably a current collector.

37. An electrode obtained by a method according to claim 35 or claim 36.

38. An assembly comprising a current collector and an electrode, wherein said electrode is the electrode as defined in any of claims 1 to 32 or 37.

39. An assembly comprising a separator and an electrode, wherein said electrode is the electrode as defined in any of claims 1 to 32 or 37.

40. Use of an electrode defined by any one of claims 1 to 32 or 37 or an assembly defined by claim 48 or 39 in a metal-ion battery, preferably a lithium-ion battery.

41. A metal ion-battery comprising an anode, a cathode, a separator, an anode current collector and a cathode current collector, such that the layer order is anode current collector/anode/separator/cathode/cathode current collector, and wherein at least one of the anode and cathode is the electrode as defined in any of claims 1 to 32 or 37.

42. A metal-ion battery according to claim 41 wherein the metal-ion battery is a solid-state battery.

43. A metal-ion battery according to claim 41 or 42 wherein the metal of said metal-ion battery is selected from lithium, sodium, potassium, calcium, magnesium and aluminium, preferably from lithium, sodium, magnesium and aluminium, preferably from lithium and sodium, and is preferably lithium.

44. A metal-ion battery according to any of claims 41 to 43 wherein the separator is a copolyester film comprising a copolyester which comprises repeating units derived from a diol, a dicarboxylic acid and a poly(alkylene oxide), wherein the copolyester film further comprises a first metal ion-containing component selected from conductive ceramic particulate materials, and wherein the film may further comprise additional metal ions from one or more sources other than said conductive ceramic particulate material.

45. A metal-ion battery according to any of claims 41 to 44 wherein said anode current collector and/or said cathode current collector are independently selected from current collectors comprising a biaxially oriented polyester substrate layer and a first metal layer on a side of the polyester substrate layer, wherein the polyester substrate layer exhibits positive thermal expansion in air at 200° C. in each of the transverse direction (TD) and machine direction (MD), wherein the polyester substrate layer has a thickness of no more than 12 μm, and wherein the first metal layer has a thickness of from 50 to 1000 nm, and preferably wherein the current collector further comprises a second metal layer having a thickness of from 50 to 1000 nm wherein the first metal layer and the second metal layer are on opposing sides of the polyester substrate layer, preferably wherein the first metal layer and, where present, the second metal layer each independently comprise at least one of aluminium, copper, nickel, titanium, silver, nickel-copper alloy, or aluminium-zirconium alloy, and preferably wherein the first and second metal layers are selected from the same material, and preferably wherein the first and second metal layers are both either aluminium or copper.

46. A method of manufacturing a metal-ion battery as defined in any of claims 41 to 45 comprising an electrode defined in any of claims 1 to 32 or 37, the method comprising the steps of:
(a) preparing or obtaining the electrode defined in any of claims 1 to 32 or 37;
(b) assembling the lithium-ion rechargeable battery, wherein the battery comprises an anode, a cathode, a separator, an anode current collector and a cathode current collector, wherein at least one of said anode and cathode is the electrode obtained from step (a).
